(19) United States
(12) Patent Application Publication
(10) Pub. No.: US 2010/0075790 A1
(43) Pub. Date: Mar. 25, 2010

(54) HYDRAULIC TENSIONING ELEMENT FOR A TRACTION MECHANISM DRIVE

(75) Inventors: Bernd Hartmann, Weisendorf (DE); Werner Petri, Erlangen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/527,630

(22) PCT Filed: Jan. 15, 2008
(86) PCT No.: PCT/EP2008/050376

§ 371 Date: Aug. 18, 2009

(30) Foreign Application Priority Data
Feb. 28, 2007 (DE) 10 2007 009 812.1

(51) Int. Cl. F16H 7/12

(52) U.S. Cl. 474/110

(57) ABSTRACT

A hydraulic tensioning element for a traction mechanism drive, having a cylinder, an axially displaceable piston guided in the cylinder, a spring element disposed between the cylinder and piston, a pressure chamber formed in the cylinder, a supply chamber for a hydraulic fluid, the chamber being formed in the piston, and a valve enabling an exchange of the hydraulic fluid between the pressure chamber and the supply chamber as a function of an actuating motion of the piston. The cylinder has a seal disposed in the housing in a stationary manner, a guide ring is provided between the piston and cylinder, and an annular chamber defined by the guide ring, the inside of the cylinder and the outside of the piston, is connected to the supply chamber in the piston via at least one fluid duct.

### BACKGROUND

The invention relates to a hydraulic tensioning element for a traction mechanism drive with a cylinder, a piston that is displaceable in the axial direction and that is guided in the cylinder, a spring element arranged between the cylinder and piston, a pressure space formed in the cylinder, and a supply space formed in the piston for a hydraulic fluid and a valve that allows hydraulic fluid to be exchanged between the pressure space and the supply space as a function of an actuating movement of the piston.

Hydraulic tensioning elements are used in traction mechanism drives for internal combustion engines and are used for tensioning a traction mechanism, for example, a belt or a chain. The tensioning element includes a cylinder that is formed as a stationary and pivotally arranged housing part, and also a piston that is connected directly or indirectly to a tensioning roller. Spring means are arranged between these elements. The spring means could be constructed as a spiral compression spring.

From DE 10 2004 047 450 A1, such a hydraulic tensioning element is known. When the piston rod is moved relative to the cylinder, a volume exchange of the hydraulic fluid is carried out between a pressure space in the cylinder and a supply space in the piston, wherein the direction of flow is dependent on the actuating movement of the piston rod. For a movement of the piston rod in the direction of the pressure space, hydraulic fluid can escape into the supply space via a leakage gap set between the piston rod and the cylinder bushing. For a reverse actuating movement of the piston, the hydraulic fluid flows from the supply space into the pressure space via a valve arranged in the base of the pressure space.

In this conventional hydraulic tensioning element, however, the accuracy of the guide for the piston is not sufficient. In addition, the piston rod seal has proven to be a weak point.

### SUMMARY

The invention is based on the objective of providing a hydraulic tensioning element in which the guide of the piston is improved and whose piston rod seal presents a better sealing effect.

To meet this objective, in a hydraulic tensioning element of the type noted above, it is provided according to the invention that the cylinder has a seal arranged stationary in the housing, a guide ring is arranged between the piston and cylinder, and an annular space bounded by the guide ring, the inside of the cylinder, and the outside of the piston is connected to the supply space in the piston via at least one fluid duct.

Through the seal provided in the tensioning element according to the invention and arranged stationary in the housing of the cylinder, the discharge of hydraulic fluid from the tensioning element is prevented. Here, the seal acts as a piston rod seal. The guide ring arranged between the piston and cylinder improves the guidance accuracy for the movement of the piston in the cylinder. Because the piston is guided by the guide ring, it moves exactly in the axial direction. Through the fluid duct that connects the supply space in the chamber to the annular space, the damping behavior of the hydraulic tensioning element can be influenced. If the hydraulic tensioning element is compressed, the piston is pushed into the cylinder. Hydraulic fluid that is located in the pressure space flows into the annular space through a leakage gap that is formed between the outside of the piston and the inside of the cylinder and from this annular space into the supply space in the piston through the fluid duct. When the piston moves out from the cylinder, the flow movement of the hydraulic fluid reverses, that is, the fluid flows out from the supply space through the non-return valve into the pressure space. Through the hydraulic tensioning element, mechanical oscillations are damped, which has an advantageous effect on the operating behavior of an internal combustion engine. The damping properties can be adapted exactly to the provided purpose of the application through the changes to the width of the leakage gap and the diameter of the fluid duct.

In the tensioning element according to the invention, the spring element can be formed as a compression spring whose inner diameter is larger than the outer diameter of the cylinder and the piston. Therefore, the compression spring could be pushed and then mounted above the piston-cylinder arrangement after the assembly of the cylinder and the piston.

In the tensioning element according to the invention, the seal could be formed as a reinforced piston rod seal. Such seals are especially robust and are distinguished by a long service life. It is preferred that the seal has one or more sealing edges contacting the housing of the cylinder and/or a deflector lip contacting the piston. The deflector lip prevents the entry of contaminating particles and an inwardly directed sealing lip prevents the discharge of oil. A static seal for the housing of the cylinder is created by the sealing edges for the housing. The deflector lip and the sealing lip for the piston create a dynamic seal for the piston or for the piston rod.

In the tensioning element according to the invention, the valve that is arranged advantageously in the end region of the piston and that is formed advantageously as a non-return valve could be formed either as a ball valve or as a plate valve. In both embodiments it is preferred that the valve has a spring that brings a moving valve element, advantageously a ball or a plate, into the closed position.

According to one improvement of the invention, pistons and cylinders of the hydraulic tensioning element could have attachment elements that could be displaced in the radial direction and that have a mounting boss. By use of the attachment elements, the hydraulic tensioning element could be mounted on a housing of an internal combustion engine or an assembly. Here it is preferred that an attachment element is combined from two sections that extend approximately across half the periphery, wherein the mounting boss is arranged on one of the sections. In the scope of the invention it could be provided that the two sections of the attachment element could be connected or are connected to each other by a plug-in or clamp or catch connection.

### BRIEF DESCRIPTION OF THE DRAWINGS

Additional advantages and details of the invention will be described below using embodiments with reference to the figures. The figures are schematic diagrams and show the following:

FIG. 1 is a cross-sectional view of a first embodiment of a hydraulic tensioning element according to the invention,

FIG. 2 is a cross-sectional view of a second embodiment of a hydraulic tensioning element according to the invention,

FIGS. 3A and 3B are a cross-sectional view and a perspective view of an attachment element,

FIGS. 4A and 4B are a cross-sectional view and a perspective view of a mounting boss,

FIGS. 5A and 5B are cross-sectional views of a third embodiment of the invention, and

FIG. 6 is a cross-sectional view of a fourth embodiment of the invention in the region of the piston rod seal.

### DETAILED DESCRIPTION OF THE PREFERRED EMBODIMENTS

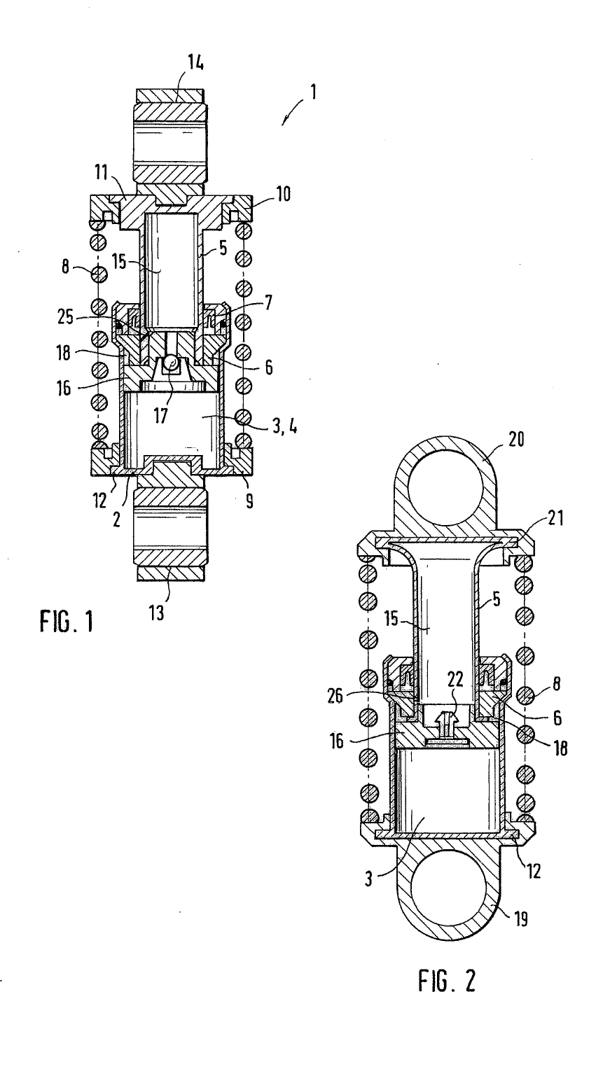

FIG. 1 shows a first embodiment of a hydraulic tensioning element 1 in a longitudinal section. The tensioning element 1 comprises a pot-shaped cylinder 2 that is created by deep drawing and that is filled with a hydraulic fluid 4. A piston 5 extends into the opening of the cylinder 2, wherein the piston 5 made from stainless steel is held by a guide ring 6 in the radial direction and is sealed by a piston rod seal 7 that is arranged fixed in place in the housing of the cylinder 2.

A spring element formed as a compression spring 8 surrounds the cylinder 2 and piston 5. The compression spring 8 is held on its end faces by attachment elements that are formed as spring retaining elements 9, 10 and that are supported on the base 11 of the piston 5 or on a collar 12 of the cylinder 2. Mounting bosses 13, 14 are attached, e.g., adhered, to the base 11 of the piston 5 or the end face of the cylinder 2.

A supply space 15 that is filled at least partially with the hydraulic fluid is located in the interior of the piston 5. Between the piston 5 and the cylinder 2 there is a plate 16 in the interior of the cylinder 2. The plate 16 is rotationally symmetric and comprises a first disk-shaped section that is adapted to the inner diameter of the cylinder 2 and a second disk-shaped section that is adapted to the diameter of the piston 5 in the region of its open end. The outer diameter of the plate 16 is selected so that a leakage gap is located between the plate 16 and the inner walls of the cylinder 2, wherein the gap width can vary from a few μm up to approximately 0.5 mm. Through hydraulic fluid 4 that passes the leakage gap, pressure can be equalized and, at the same time, the movement of the piston 5 is damped.

The plate 16 has a central valve that is formed in the illustrated embodiment as a ball valve 17. The ball of the ball valve 17 is pressed by a not-shown spring against the axial duct in the interior of the plate 16 and prevents, when the valve is closed, the flow of hydraulic fluid 4 from the pressure space 3 into the supply space 15.

For the assembly, the divided spring retaining element 9 is pushed onto the cylinder 2. The inner diameter of the compression spring is larger than the outer diameter of the cylinder 2 and the piston 5. After the compression spring 8 is compressed, the divided spring retaining element 10 is placed on the other side. Then the compression spring 8 is released, so that, by expanding, the bias of the compression spring presses the spring retaining elements 9, 10 away from each other.

During the operation of the tensioning element 1 in the belt-driving mode of an internal combustion engine, if the piston 5 is pressed toward the cylinder 2, then the tensioning element 1 is compressed and the hydraulic fluid 4 in the cylinder 2 is set under pressure by the movement of the plate connected to the piston 5. The hydraulic fluid flows through the leakage gap into the supply space 15 in the piston 5. In addition, the hydraulic fluid 4 also flows into the annular space 18 that is defined by the top side of the plate 16 in the axial direction and the inner surface of the cylinder 2 in the radial direction and also the piston rod seal 8. The farther the piston 5 moves inward, the larger the annular space 18 becomes. The annular space 18 is connected to the supply space 15 by a radial fluid duct 25, so that hydraulic fluid forced from the pressure space 3 flows via the leakage gap into the annular space 18 and from there into the supply space 15. Because the annular space 18 or the supply space 15 is filled only partially with the hydraulic fluid 4, the pressure is advantageously less strongly dependent on the instantaneous position of the piston 5.

FIG. 2 shows a second embodiment of a hydraulic tensioning element, wherein matching reference symbols are used for identical components. As in the first embodiment, the piston 5 can be displaced in the axial direction in the cylinder 2. The piston 5 and cylinder 2 are surrounded by the compression spring 8. Mounting bosses 19, 20 that each have a groove are pushed in the radial direction over the collar 12 of the cylinder 2 or a collar 21 in the region of the base of the piston 5.

The piston 5 has a cylindrical basic shape. On its outer end, the piston 5 is enlarged in the radial direction, so that it can hold a larger quantity of hydraulic fluid.

The pressure space 3 in the cylinder 2 and the supply space 15 in the piston 5 are connected to each other via the plate 16. A plate valve 22 closes an axial duct between the supply space 15 and the pressure space 3. The plate valve 22 comprises a plate-shaped closing element that can be moved in the axial direction along its movement path by hydraulic forces acting from the two sides and that opens or closes the axial connection duct. Analogous to the first embodiment, the annular space 18 formed above the plate 16 is connected to the supply space 15 via a fluid duct 26.

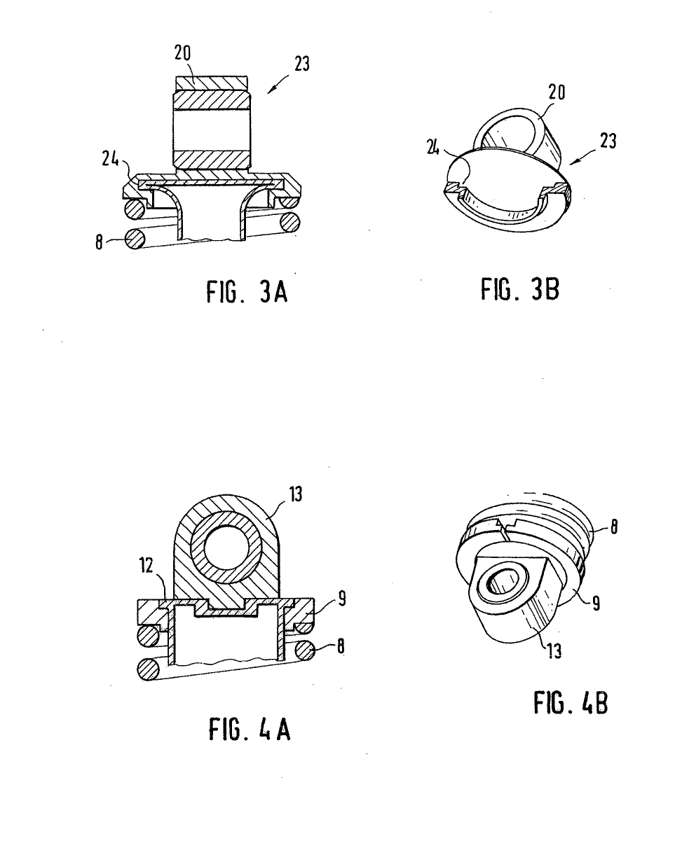

FIGS. 3A and 3B show a cross-sectional view and a perspective view of an attachment element. The attachment element formed as a spring retaining element 23 comprises the mounting boss 20 and a section that has a groove 24 and that extends across half the periphery. An associated, complementary second section is not shown in FIG. 3b. The two sections are connected to each other by a plug-in connection.

FIGS. 4A and 4B show a mounting boss in a cross-sectional view and a perspective view. The mounting boss 13 is adhered onto the end face of the cylinder 2 and is connected to this face with a non-positive (friction) fit and a positive locking fit. In the installed state, the two-part, annular spring retaining element 9 contacts the collar 12 of the cylinder 2. The compression spring 8 contacts the other side of the spring retaining element 9.

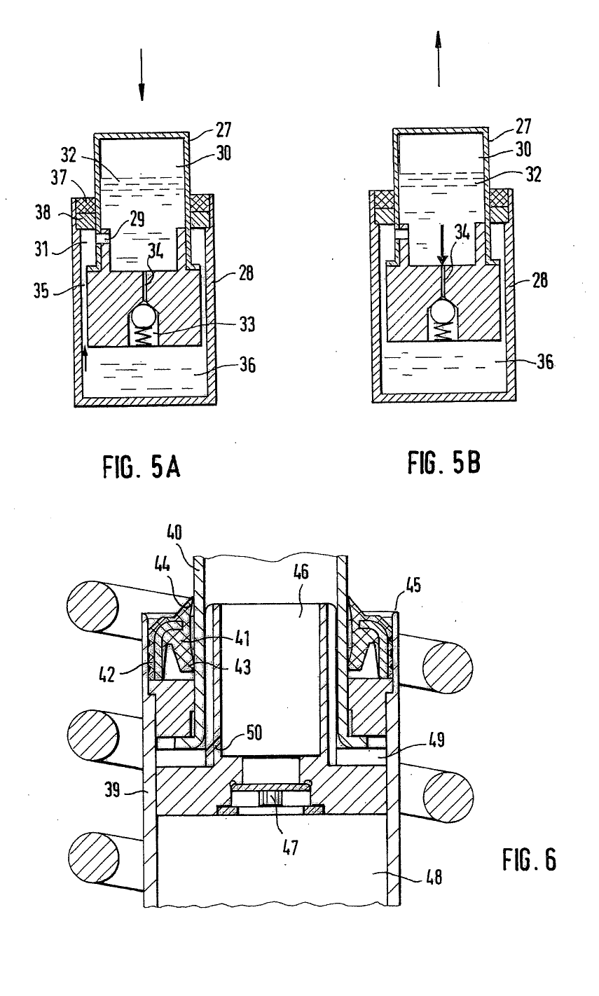

In FIGS. 5A and 5B, a piston 27 and a cylinder 28 of a hydraulic tensioning element according to a third embodiment are shown. The piston 27 has a fluid duct 29 that extends in the radial direction and that connects the supply space 30 to the annular space 31. The supply space 30 is filled partially with hydraulic fluid 32. The cylinder 28 has a seal 37 fixed in place and a guide ring 38 arranged between the cylinder 28 and piston 27.

On the free end of the piston 27 there is a ball valve 33 that opens or closes an axial fluid duct 34. The leakage gap 35 that is formed between the inner wall of the cylinder 28 and the outside of the piston 27 allows hydraulic fluid to flow from the pressure space 36 into the annular space 31. The leakage gap 35 is shown enlarged in FIGS. 5A and 5B. When the tensioning element is compressed as shown in FIG. 5A by the downward directed arrow and the piston 27 is pushed into the cylinder 28, hydraulic fluid located in the pressure space 36 is set under pressure and forced through the leakage gap 35 into the annular space 31, from where it reaches through the fluid duct 29 into the supply space 30.

In the opposite case that is shown in FIG. 5B, the piston 27 moves out from the cylinder 28. In the pressure space 36, a low pressure is created that overcomes the spring force of the ball valve 33, so that this valve opens and hydraulic fluid 32 flows from the supply space 30 via the fluid duct 34 into the pressure space.

FIG. 6 shows a cross-sectional view of a fourth embodiment of the invention in the region of the piston rod seal. Between a cylinder 39 and a piston 40 there is a seal 41 that is formed as a reinforced piston rod seal. The seal 41 has several sealing edges 42 contacting the inside of the cylinder 39 and deflector lips 43, 44 contacting the piston 40. The sealing edges 42 create a static seal for the housing of the cylinder 39. The deflector lips 43, 44 and an optional sealing lip create a dynamic seal for the piston 40. As is to be seen in FIG. 6, on its upper end, the housing of the cylinder 39 has a flanged edge 45 by which the seal 41 is held between the cylinder 39 and the piston 40.

The hydraulic fluid flows from a supply space 46 via a plate valve 47 into a pressure space 48. An annular space 49 is connected to the supply space 46 via a fluid duct 50 shown schematically.

### REFERENCE SYMBOLS

1 Tensioning element
2 Cylinder
3 Pressure space
4 Hydraulic fluid
5 Piston
6 Guide ring
7 Piston rod seal
8 Compression spring
9 Spring retaining element
10 Spring retaining element
11 Base
12 Collar
13 Mounting boss
14 Mounting boss
15 Supply space
16 Plate
17 Ball valve
18 Annular space
19 Mounting boss
20 Mounting boss
21 Collar
22 Plate valve
23 Spring retaining element
24 Groove
25 Fluid duct
26 Fluid duct
27 Piston
28 Cylinder
29 Fluid duct
30 Supply space
31 Annular space
32 Hydraulic fluid
33 Ball valve
34 Fluid duct
35 Leakage gap
36 Pressure space
37 Seal
38 Guide ring
40 Piston
41 Seal
42 Sealing edge
43 Deflector lip
44 Deflector lip
45 Flanged edge
46 Supply space
47 Plate valve
48 Pressure space
49 Annular space
50 Fluid duct

1. Hydraulic tensioning element for a traction mechanism drive comprising a cylinder, a piston that is displaceable in an axial direction and that is guided in the cylinder, a spring element arranged between the cylinder and the piston, a pressure space formed in the cylinder, a supply space formed in the piston for a hydraulic fluid, and a valve that allows hydraulic fluid to be exchanged between the pressure space and the supply space as a function of an actuating movement of the piston, the cylinder has a seal arranged fixed in position in the housing, a guide ring is arranged between the piston and the cylinder, and an annular space defined by the guide ring, an inside of the cylinder, and an outside of the piston is connected to the supply space in the piston via at least one fluid duct.

2. Tensioning element according to claim 1, wherein the spring element comprises a compression spring having an inner diameter that is larger than an outer diameter of the cylinder and the piston.

3. Tensioning element according to claim 1, wherein the piston is made from stainless steel.

4. Tensioning element according to claim 1, wherein the seal is formed as a reinforced piston rod seal.

5. Tensioning element according to claim 1, wherein the seal has at least one of a sealing edge contacting the housing of the cylinder, a deflector lip contacting the piston or a sealing lip sealing the piston on the inside.

6. Tensioning element according to claim 1, wherein the valve is formed as a ball valve having a spring.

7. Tensioning element according to claim 1, wherein the valve is formed as a plate valve having a spring.

8. Tensioning element according to claim 1, wherein the piston and the cylinder have attachment elements that can be displaced in a radial direction and that have a mounting boss.

9. Tensioning element according to claim 8, wherein the attachment element is combined from two complementary sections that extend approximately across half a periphery, and the mounting boss is arranged on one of the sections.

10. Tensioning element according to claim 9, wherein the two sections are connectable to each other by a plug-in, clamp or catch connection.
